(19) United States
(12) Patent Application Publication
(10) Pub. No.: US 2008/0252126 A1
(43) Pub. Date: Oct. 16, 2008

(54) POWER ACTUATED EASY ENTRY SEAT

(75) Inventors: John Bartoi, Troy, MI (US); John R. Sims, Dearborn, MI (US); Mark Keyser, Lake Orion, MI (US); Wee Gam, Troy, MI (US); Tony Centi, Grosse Ile, MI (US); David J. Abdella, Shelby Twp., MI (US)

Correspondence Address: BROOKS KUSHMAN P.C. / LEAR CORPORATION, 1000 TOWN CENTER, TWENTY-SECOND FLOOR, SOUTHFIELD, MI, 48075-1238, US

(73) Assignee: LEAR CORPORATION, Southfield, MI (US)

(21) Appl. No.: 11/733,501

(22) Filed: Apr. 10, 2007

(51) Int. Cl. B60N 2/12; B60N 2/02

(52) U.S. Cl. 297/341; 296/65.18

(57) ABSTRACT

A seat is provided including a seat body assembly having a seat bottom that is configured for movement between a rear position and a forward position, and a seat back connected to the seat bottom. The seat back may be configured to pivot between a first position and a second position. The seat bottom may be moveable to the forward position when the seat back pivots to the second position. The seat further includes an electric actuator assembly associated with the seat body assembly that permits the seat back to pivot to the second position when the electric actuator assembly is actuated.

### BACKGROUND OF THE INVENTION

1. Field of the Invention

This invention relates to power actuated easy entry seats.

2. Background Art

Examples of easy entry seats include U.S. Pat. Nos. 7,097,250; 6,857,702; 6,695,275; 6,619,741; 6,341,819; 6,139,104; 5,873,629; 5,740,999; 5,626,392; 5,597,206; 5,524,504; 5,352,019; 4,634,180; 4,569,557; 4,440,442; 4,422,690; 3,931,995; and U.S. Publication No. 2003/0080598.

### SUMMARY OF THE INVENTION

A power actuated easy entry seat is provided herein. In at least a first embodiment, the seat comprises a seat body assembly having a seat bottom that is configured for movement between a rear position and a forward position, and a seat back that is connected to the seat bottom, the seat back being configured to pivot between a first position and a second position. The seat bottom may be moveable to the forward position when the seat back pivots to the second position. The seat further comprises an electric actuator assembly associated with the seat body assembly that permits the seat back to pivot to the second position when the electric actuator assembly is actuated.

In at least one implementation of the of the first embodiment, the actuator assembly is attached to the seat body assembly.

In at least another implementation of the first embodiment, the electric actuator assembly may comprise a solenoid.

In at least another implementation of the first embodiment, the seat may further comprise a connector having a first end and a second end. The connector may be connected at the first end to the electric actuator assembly and may be connected at the second end to the seat body assembly. The electric actuator assembly may apply a force to the connector when the electric actuator assembly is actuated and the connector may permit the seat back to pivot to the second position when the electric actuator assembly applies force to the connector.

In at least one variation of this implementation, the connector comprises a metal cable and a sleeve, the metal cable being slidably disposed within the sleeve.

In at least another implementation of the first embodiment, a switch may be associated with the seat body assembly for actuating the electric actuator assembly. In at least one variation of this implementation, the seat further comprises an electrical wire assembly electrically connecting the switch to the electric actuator assembly. In a further variation of this implementation, the switch may be attached to the seat body assembly, for example, to the seat back.

In at least another implementation of the first embodiment, a spring may be connected to the seat body assembly, the spring causing the seat bottom to move towards the forward position when the seat back pivots to the second position.

In at least a second embodiment, a vehicle seat is provided comprising a rail assembly configured for attachment to a floor of a vehicle. The vehicle seat further comprises a seat body assembly having a seat bottom that is slidably connected to the rail assembly, the seat bottom being configured to slide between a rear position and a forward position. The seat body assembly may further have a seat back that is pivotally connected to the seat bottom and configured to pivot with respect to the seat bottom between an upright position and a folded position. The seat bottom may be configured to slide to the forward position when the seat back pivots to the folded position. The seat further comprises a spring that is connected to the seat body assembly, the spring urging the seat back to pivot towards the folded position. The seat may further have a release mechanism connected to the seat body assembly for selectively locking and releasing the seat back with respect to the seat bottom. The vehicle seat further includes an electric actuator assembly attached to the seat body assembly, the electric actuator assembly being configured to release the release mechanism when the electric actuator assembly is actuated.

In at least one implementation of the second embodiment, the vehicle seat further comprises a cable assembly and the actuator assembly comprises a solenoid. The cable assembly may have a first end and a second end. The first end may be connected to the solenoid and the second end being connected to the release mechanism. The solenoid may be configured to pull on the cable assembly when an electric actuator assembly is actuated such that the cable assembly releases the release mechanism. In at least one variation of this implementation, the vehicle seat further comprises an electric switch mounted on the seat body assembly and being electrically connected to the electric actuator assembly for actuating the electric actuator assembly. In a further variation of this implementation, the electric switch may be mounted to the seat back and the electric actuator assembly may be mounted to the seat bottom.

In at least another implementation of the second embodiment, the seat may further comprise a spring connected to the seat bottom, the spring biasing the seat bottom to slide toward the forward position.

In at least a third embodiment, an automotive vehicle is provided comprising a floor and a rail assembly mounted to the floor. The automotive vehicle further comprises a seat body assembly connected to the rail assembly, the seat body assembly having a seat bottom slidably mounted on the rail assembly and configured to slide between a rear position and a forward position. The seat body assembly further includes a seat back that is pivotally mounted to the seat bottom and may be configured to pivot between an upright position and a folded position, the seat bottom being released to slide to the forward position when the seat back is in the folded position. The seat body assembly further includes a first spring that may be connected to the seat back to urge the seat back towards the folded position. The seat body assembly may further include a second spring that is connected to the seat bottom, the second spring urging the seat bottom towards the forward position to cause the seat bottom to slide to the forward position when the seat back pivots to the folded position. The automotive vehicle may further include a release mechanism that is connected to the seat body assembly for selectively locking and releasing the seat back to pivot. The automotive vehicle may further include an electric actuator assembly mounted to the seat body assembly and connected to the release mechanism. The electric actuator assembly may be configured to release the release mechanism when the electric actuator assembly is actuated.

In at least one implementation of the third embodiment, the automotive vehicle may further comprise an electric switch that is mounted to the seat body assembly. The electric switch may be electrically connected to the electric actuator assembly for actuating the electric actuator assembly. In at least one variation of this embodiment, the electric switch is mounted on the seat back and the electric actuator assembly is mounted on the seat bottom. In a further variation of this implementation, the automotive vehicle may further comprise a cable assembly having a first end and a second end and the electric actuator assembly may comprise a solenoid. The first end may be attached to the solenoid and the second end may be attached to the release mechanism. The solenoid may be configured to pull on the first end causing the second end to pull on and release the release mechanism when the electric actuator assembly is actuated. In a further variation of this implementation, the seat body assembly may further comprise a third spring attached to the seat bottom. The third spring may urge the seat bottom towards the forward position. The second and third spring may act in concert to move the seat bottom to the forward position when the electric actuator assembly is actuated.

### BRIEF DESCRIPTION OF THE DRAWINGS

FIG. 1 is a cutaway side elevation view of an automotive vehicle equipped with an embodiment of the seat of the present invention;

FIG. 2 is a cutaway perspective view of the seat of FIG. 1 prior to actuation of an easy-entry feature;

FIG. 3 is a cutaway perspective view of the seat of FIG. 2 subsequent to actuation of the easy-entry feature; and

FIG. 4 is a cutaway, fragmented perspective view of an actuator assembly and a portion of the seat of FIG. 1.

### DETAILED DESCRIPTION OF THE PREFERRED EMBODIMENT(S)

Reference will now be made in detail to the illustrated embodiments of the present invention which include the best modes of practicing the invention presently known to the inventors. The following descriptions are merely exemplary in nature and in no way intended to limit the invention, its application, or uses. The Figures are not necessarily drawn to scale. Specific details disclosed herein are not to be interpreted as limiting, but merely as a representative basis for any aspect of the invention and/or as a representative basis for teaching one skilled in the art to variously employ the present invention.

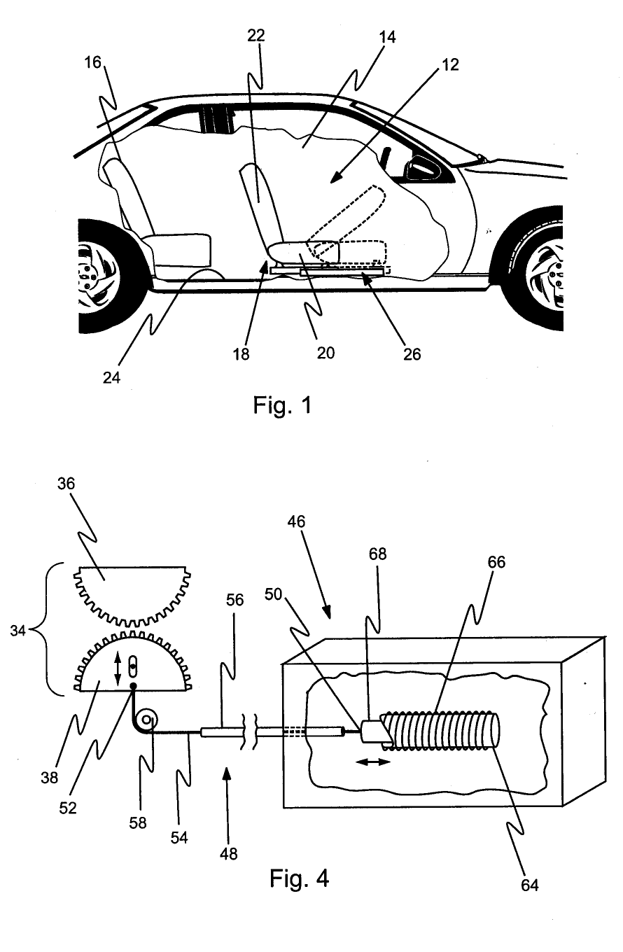

FIG. 1 illustrates a vehicle 10 equipped with an embodiment of an automotive seat 12 having an easy-entry feature that provide a passenger with access to a rear portion of the vehicle's passenger compartment at the touch of a button. Vehicle 10 is a two door automobile having a passenger compartment 14 including a front seat (seat 12) and a rear seat 16, the seat 12 and rear seat 16 being capable of seating passengers. While vehicle 10 illustrated in FIG. 1 is an automobile, it should be understood by those of ordinary skill in the art that the seat 12 may be used in any type of vehicle including, but not limited to, air craft, water craft, rail vehicles and space craft.

The seat 12 includes a seat body assembly 18 having a seat bottom 20 and a seat back 22. Seat bottom 20 may include seat bottom cushion 21 and seat back 22 may include seat back cushion 23. Vehicle 10 further includes a vehicle floor 24. A rail assembly 26 is mounted to vehicle floor 24 and seat bottom 20 is slidably mounted to rail assembly 26. Seat body assembly 18 may move between a rear position (illustrated in FIG. 1 in solid lines) and a forward position (illustrated in FIG. 1 in phantom lines). The seat back 22 is pivotally connected to seat bottom 20 and is configured to pivot between a first or upright position (illustrated in FIG. 1 in solid lines) and a second or folded position (illustrated in FIG. 1 in phantom lines). A passenger desiring to occupy rear seat 16 may do so by first pivoting seat back 22 from the upright position to the folded position and moving seat body assembly 18 from the rear position to the fold up position. When seat body assembly 18 is in the forward position and seat back 22 is in the folded position, sufficient clearance behind seat 12 is provided to allow a passenger to enter a rear portion of the passenger compartment 14.

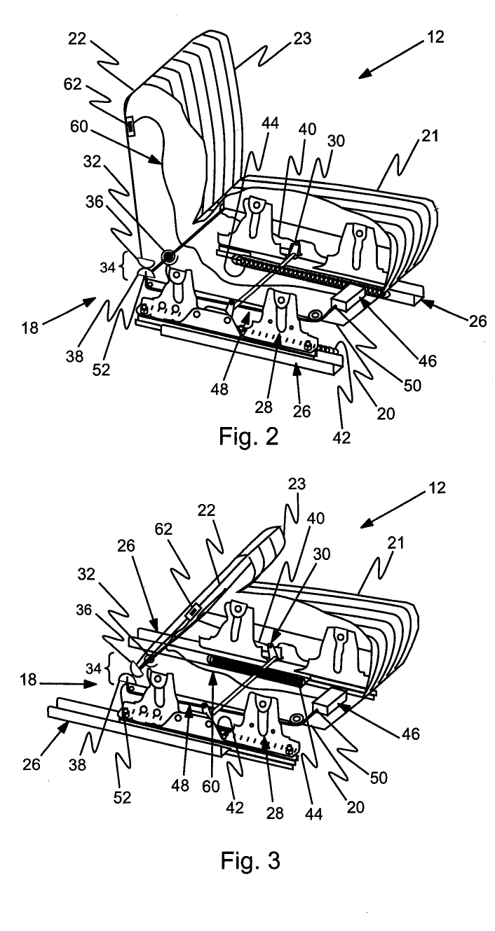

FIG. 2 illustrates the seat 12 with seat body assembly 18 in the rear position. Seat body assembly 18 is slidably mounted to rail assembly 26 by mounting assembly 28. Seat 12 further includes a slide locking mechanism 30 which controls the sliding motion of seat body assembly 12 along rail assembly 26. Seat body assembly 18 is restrained from sliding along rail assembly 26 when slide locking mechanism 30 is locked and free to slide along rail assembly 26 when slide locking mechanism 30 is unlocked. In the illustrated embodiment, slide locking mechanism 30 may be selectively unlocked by an occupant of seat 12 through the use of a front mounted pull bar (not shown).

A first spring 32 is mounted to seat body assembly 18 and urges seat back 22 to pivot towards the folded position. In the embodiment illustrated in FIG. 2, first spring 32 is a torsion spring. In other embodiments, any type of spring or other device capable of biasing seat back 22 towards the folded position may be used.

Release mechanism 34 restrains seat back 22 from pivoting towards the folded position. Release mechanism 34 may be selectively released to select a degree of recline for seat back 22. An occupant may operate release mechanism 34 through the use of a lever (not shown) mounted to an outboard portion of seat body assembly 18. In the illustrated embodiment, release mechanism 34 includes an upper portion 36 mounted to seat back 22 and a lower portion 38 mounted to seat bottom 20. Upper portion 36 and lower portion 38 include teeth. When upper portion 36 and lower portion 38 are in close proximity, their respective teeth engage each other to prevent seat back 22 from pivoting to the folded position. When the upper portion 36 and the lower portion 38 are separated such that their teeth are disengaged, seat back 22 is free to pivot towards the folded position under the force of the first spring 32. In other embodiments, any mechanism effective to restrain seat back 22 from pivoting to the folded position may be used.

Seat 12 further includes a slide release cable 40 connecting seat back 22 to slide locking mechanism 30. When seat back 22 is in the upright position, as illustrated in FIG. 2, the slide release cable 40 has slack and does not apply any tension to slide locking mechanism 30. As seat back 22 pivots to the folded position the slack in slide release cable 40 is taken up. As seat back 22 continues its pivot to the folded position, slide release cable 40 pulls back on and releases slide locking mechanism 30 permitting seat body assembly 18 to slide along rail assembly 26.

Seat 12 further includes a second spring 42 and a third spring 44 which connect seat bottom 20 to a stationary portion of rail assembly 26 as illustrated in FIG. 2. When seat body assembly 18 is in the rear position, second spring 42 and third spring 44 are in tension. When slide locking mechanism 30 is released, seat body assembly 18 is free to slide along rail assembly 26, and second spring 42 and third spring 44 pull seat body assembly 18 towards the forward position. In other embodiments, the second spring 42 and the third spring 44 may be connected to the mounting assembly 28 or to other parts of seat body assembly 18. In other embodiments, the second spring 42 and the third spring 44 may push seat body assembly 18 rather than pull it. In other embodiments, a single spring such as second spring 42 may be sufficient to move seat body assembly 18 to the forward position.

Seat 12 further includes an electric actuator assembly 46. Electric actuator assembly 46 may be battery powered or wired into the vehicle's electrical system. Actuator assembly 46 includes a connector 48 that connects the electric actuator assembly 46 directly to the release mechanism 34. In other embodiments, the electric actuator assembly 46 may be connected to release mechanism 34 indirectly through other components. In the embodiment illustrated in FIG. 2, electric actuator assembly 46 is mounted to seat bottom 20. In other embodiments, electric actuator assembly 46 may be mounted to seat back 22 or elsewhere on seat 12. Alternatively, electric actuator assembly 46 may be mounted on the floor 24 or to other parts of vehicle 10.

As illustrated, connector 48 is a Bowden cable assembly including a metal cable and a sleeve in which the metal cable is free to slide (see FIG. 4). Alternatively, connector 48 may be a linkage system including a series of connecting rods or any other device effective to transmit a push or a pull from the electric actuator assembly 46 to the release mechanism 34. Connector 48 includes a first end 50 connected to the electric actuator assembly 46 and a second end 52 connected to release mechanism 34. Actuator assembly 46, when actuated, will apply a force (for example a push or a pull) to the first end 50 of connector 48. That force will be transmitted along the connector 48 to the release mechanism 34. In the illustrated embodiment wherein connector 48 comprises a Bowden cable assembly, electric actuator assembly 46 pulls on a cable portion 54 of the connector 48 which slides with respect to a sleeve portion 56 (see FIG. 4) and pulls on lower portion 38 of release mechanism 34 causing lower portion 38 to disengage from upper portion 36, thereby releasing release mechanism 34 and permitting seat back 22 to pivot toward the folded position. In some embodiments, the movement of cable portion 54 may be guided by a pulley 58 (see FIG. 4) or by some other device capable of changing the direction of the force applied by cable portion 54.

Electric actuator assembly 46 may be electrically actuated and thus may require minimal effort to effect the pivoting of seat back 22 from the upright to the folded position. In some embodiments, electric actuator assembly 46 may be actuated remotely such as through RF or infrared transmissions or through an electronic signal transmitted to electric actuator assembly 46 through a wire. In a preferred embodiment, an electronic wire assembly 60 and an electric switch 62 allow a user to actuate electric actuator assembly 46. Electric switch 62 may be mounted anywhere inside the vehicle 10, and connected by electronic wire assembly 60 to electric actuator assembly 46. Preferably, electric switch 62 will be mounted on seat body assembly 18. More preferably, electric switch 62 will be mounted to an outboard portion of seat back 22. The electric switch 62, when switched, transmits a signal through electronic wire assembly 60 to electric actuator assembly 46 thereby actuating electric actuator assembly 46.

With reference to FIG. 3, once the electric actuator assembly 46 has been actuated, it pulls on connector 48 causing lower portion 38 of release mechanism 34 to separate from upper portion 36 which, in turn, frees the seat back 22 to pivot about its connection to seat bottom 20 under the force of the first spring 32. As seat back 22 pivots to the folded position, slide release cable 40 tightens and unlocks slide locking mechanism 30 which frees seat body assembly 18 to slide along rail assembly 26 to the forward position under the force exerted by second spring 42 and third spring 44. In the illustrated arrangement, a passenger seeking to enter the rear portion of passenger compartment 14 need only switch electric switch 62 to effect a forward fold of seat back 22 and a forward translation of seat body assembly 18.

With reference to FIG. 4, an embodiment of an electric actuator assembly 46 is illustrated. Electric actuator assembly 46 includes a solenoid 64 comprising a series of coils 66 wrapped around an armature 68 which is configured to slide between a first position and a second position. When coils 66 are electrified, armature 68 moves from the first position to the second position. The first end 50 of connector 48 is attached to the armature 68 and is pulled as armature 68 moves from the first position to the second position. When the first end 50 is pulled by armature 68, the second end 52 pulls on the lower portion 38 of release mechanism 34, effecting the disengagement of the lower portion 38 from the upper portion 36. In other embodiments, any mechanism that is effective to release release mechanism 34 when actuated may be used.

While embodiments of the invention have been illustrated and described, it is not intended that these embodiments illustrate and describe all possible forms of the invention. Rather, the words used in the specification are words of description rather than limitation, and it is understood that various changes may be made without departing from the spirit and scope of the invention.

What is claimed is:

1. A seat comprising:
a seat body assembly having a seat bottom configured for movement between a rear position and a forward position and a seat back connected to the seat bottom, the seat back being configured to pivot between a first position and a second position, the seat bottom being moveable to the forward position when the seat back pivots to the second position; and
an electric actuator assembly associated with the seat body assembly that permits the seat back to pivot to the second position when the electric actuator assembly is actuated.

2. The seat of claim 1 wherein the actuator assembly is attached to the seat body assembly.

3. The seat of claim 1 wherein the electric actuator assembly comprises a solenoid.

4. The seat of claim 1 further comprising a connector having a first end and a second end, the connector being connected at the first end to the electric actuator assembly and the connector being connected at the second end to the seat body assembly, the electric actuator assembly applying force to the connector when the electric actuator assembly is actuated and the connector permitting the seat back to pivot to the second position when the electric actuator assembly applies force to the connector.

5. The seat of claim 4 wherein the connector comprises a metal cable and a sleeve, the metal cable being slidably disposed within the sleeve.

6. The seat of claim 1 further comprising a switch associated with the seat body assembly for actuating the electric actuator assembly.

7. The seat of claim 6 further comprising an electrical wire assembly electrically connecting the switch to the electric actuator assembly.

8. The seat of claim 7 wherein the switch is attached to the seat body assembly.

9. The seat of claim 8 wherein the switch is attached to the seat back.

10. The seat of claim 1 further comprising a spring connected to the seat body assembly, the spring causing the seat bottom to move towards the forward position when the seat back pivots to the second position.

11. A vehicle seat comprising:
a rail assembly configured for attachment to a floor of a vehicle;
a seat body assembly having a seat bottom slidably connected to the rail assembly, the seat bottom being configured to slide between a rear position and a forward position, the seat body assembly further having a seat back pivotally connected to the seat bottom and configured to pivot with respect to the seat bottom between an upright position and a folded position, the seat bottom being configured to slide to the forward position when the seat back pivots to the folded position;
a spring connected to the seat body assembly, the spring urging the seat back to pivot towards the folded position;
a release mechanism connected to the seat body assembly for selectively locking and releasing the seat back with respect to the seat bottom; and
an electric actuator assembly attached to the seat body assembly, the electric actuator assembly being configured to release the release mechanism when the electric actuator assembly is actuated.

12. The vehicle seat of claim 11 further comprising a cable assembly, and wherein the actuator assembly comprises a solenoid, the cable assembly having a first end and a second end, the first end being connected to the solenoid and the second end being connected to the release mechanism, the solenoid being configured to pull on the cable assembly when the electric actuator assembly is actuated such that the cable assembly releases the release mechanism.

13. The vehicle seat of claim 12 further comprising an electric switch mounted on the seat body assembly and being electrically connected to the electric actuator assembly for actuating the electric actuator assembly.

14. The vehicle seat of claim 13 wherein the electric switch is mounted to the seat back and wherein the electric actuator assembly is mounted to the seat bottom.

15. The vehicle seat of claim 11 further comprising a spring connected to the seat bottom, the spring biasing the seat bottom to slide toward the forward position.

16. An automotive vehicle comprising:
a floor;
a rail assembly mounted to the floor;
a seat body assembly connected to the rail assembly, the seat body assembly having a seat bottom slidably mounted on the rail assembly and configured to slide between a rear position and a forward position, a seat back pivotally mounted to the seat bottom and configured to pivot between an upright position and a folded position, the seat bottom being released to slide to the forward position when the seat back is in the folded position, the seat body assembly further including a first spring connected to the seat back for urging the seat back towards the folded position, and a second spring connected to the seat bottom, the second spring urging the seat bottom towards the forward position to cause the seat bottom to slide to the forward position when the seat back pivots to the folded position;
a release mechanism connected to the seat body assembly for selectively locking and releasing the seat back to pivot; and
an electric actuator assembly mounted to the seat body assembly and connected to the release mechanism, the electric actuator assembly being configured to release the release mechanism when the electric actuator assembly is actuated.

17. The automotive vehicle of claim 16 further comprising an electric switch mounted to the seat body assembly, the electric switch being electrically connected to the electric actuator assembly for actuating the electric actuator assembly.

18. The automotive vehicle of claim 17 wherein the electric switch is mounted on the seat back and the electric actuator assembly is mounted on the seat bottom.

19. The automotive vehicle of claim 18 further comprising a cable assembly having a first end and a second end and wherein the electric actuator assembly comprises a solenoid, the first end being attached to the solenoid, the second end being attached to the release mechanism, the solenoid being configured to pull on the first end causing the second end to pull on and release the release mechanism when the electric actuator assembly is actuated.

20. The automotive vehicle of claim 19 wherein the seat body further comprises a third spring attached to the seat bottom, the third spring urging the seat bottom towards the forward position, and wherein the second and third spring acting in concert to move the seat bottom to the forward position when the electric actuator assembly is actuated.
